(19) United States
(12) Patent Application Publication
(10) Pub. No.: US 2021/0293561 A1
(43) Pub. Date: Sep. 23, 2021

(54) TRAVELING ROUTE SETTING DEVICE, A METHOD OF SETTING TRAVELING ROUTE, AND NON-TRANSITORY COMPUTER-READABLE STORAGE MEDIUM

(71) Applicant: HONDA MOTOR CO., LTD., Tokyo (JP)

(72) Inventor: Sho TAMURA, Wako-shi (JP)

(21) Appl. No.: 17/198,561

(22) Filed: Mar. 11, 2021

(30) Foreign Application Priority Data
Mar. 19, 2020 (JP) 2020-048913

(51) Int. Cl. G01C 21/36; G01C 21/00; G05D 1/02

(52) U.S. Cl. CPC G01C 21/36; G05D 1/0212; G01C 21/3807

(57) ABSTRACT

A traveling route setting device for setting a traveling route of a moving body, comprises an acquisition unit for acquiring a traveling environment represented by map data as a first traveling environment and a traveling environment detected by a sensor as a second traveling environment, and a setting unit for setting the traveling route based on the first and the second traveling environments, wherein in a case that a degree of matching between the first and the second traveling environments does not satisfy a reference, if a travelable surface that is a traveling surface on which the moving body can actually travel and is detected by the sensor becomes narrow, the setting unit sets the traveling route based on a boundary line of the travelable surface.

### CROSS-REFERENCE TO RELATED APPLICATION(S)

This application claims priority to and the benefit of Japanese Patent Application No. 2020-048913, filed on Mar. 19, 2020, which is hereby incorporated by reference herein in its entirety.

### BACKGROUND OF THE INVENTION

### Field of the Invention

The present invention relates to a traveling route setting device.

### Description of the Related Art

Driving support called automated driving or the like can be performed by, for example, providing, on a vehicle, a plurality of sensors configured to detect a traveling environment and setting the traveling route of the vehicle based on the detection results of these. Japanese Patent Laid-Open No. 2013-36856 describes calculating the detection results of a plurality of sensors based on the degree of degradation of each sensor, thereby specifying a self-vehicle position and performing driving support.

Japanese Patent Laid-Open No. 2013-36856 describes performing driving support by further referring to a traveling environment represented by map data. However, there is room for improvement to make the driving support described in Japanese Patent Laid-Open No. 2013-36856 more appropriate using the traveling environment detected by the plurality of sensors and the traveling environment represented by the map data. This also applies to a variety of moving bodies.

### SUMMARY OF THE INVENTION

The present invention implements more appropriate driving support.

One of the aspects of the present invention provides a traveling route setting device for setting a traveling route of a moving body, comprising an acquisition unit for acquiring a traveling environment represented by map data as a first traveling environment, and acquiring a traveling environment detected by a sensor mounted in the moving body as a second traveling environment, and a setting unit for setting the traveling route of the moving body based on the first traveling environment and the second traveling environment, wherein in a case in which a degree of matching between the first traveling environment and the second traveling environment does not satisfy a reference, if a travelable surface that is a traveling surface on which the moving body can actually travel and is detected by the sensor becomes narrow, the setting unit sets the traveling route based on a boundary line of the travelable surface.

Further features of the present invention will become apparent from the following description of exemplary embodiments with reference to the attached drawings.

### BRIEF DESCRIPTION OF THE DRAWINGS

FIG. 1 is a view showing an example of the arrangement of a vehicle according to an embodiment;

FIG. 2 is a flowchart showing an example of a method of setting the traveling route of the vehicle;

FIG. 3A is a schematic view for explaining the contents of a traveling environment;

FIG. 3B is a schematic view for explaining the contents of a traveling environment;

FIG. 3C is a schematic view for explaining the contents of a traveling environment;

FIG. 4 is a schematic view showing another example of the traveling environment;

FIG. 5 is a schematic view showing still another example of the traveling environment; and

FIG. 6 is a schematic view showing still another example of the traveling environment.

### DESCRIPTION OF THE EMBODIMENTS

Hereinafter, embodiments will be described in detail with reference to the accompanying drawings. It should be noted that the following embodiments are not intended to limit the scope of the appended claims, and that not all the combinations of features described in the embodiments are necessarily essential to the present invention. Of a plurality of features described in the embodiments, two or more features may arbitrarily be combined. In addition, the same reference numerals denote the same or similar parts, and a repetitive description will be omitted.

### Example of Arrangement of Vehicle

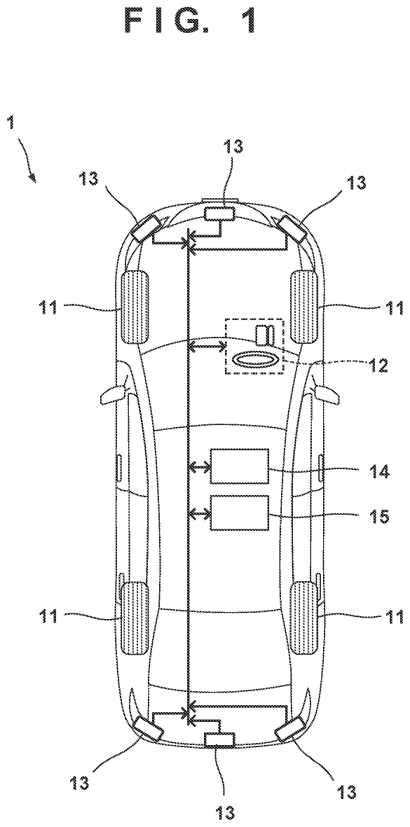

FIG. 1 shows an example of the arrangement of a vehicle 1 according to an embodiment. The vehicle 1 includes a traveling unit 11, a driving operation unit 12, a traveling environment detection unit 13, a storage unit 14, and a control unit 15. In this embodiment, the vehicle 1 is a four-wheeled vehicle including, as the traveling unit 11, a pair of front wheels and a pair of rear wheels. However, the number of wheels is not limited to this example, and as another embodiment, the vehicle 1 may be a two-wheeled vehicle, a three-wheeled vehicle, or the like. Alternatively, the traveling unit 11 may be formed by a continuous track (crawler type).

The driving operation unit 12 is a driving operation mechanism configured to perform the driving operation (mainly acceleration, braking, and steering) of the vehicle 1, and includes, for example, an acceleration operator, a braking operator, a steering operator, and the like. An accelerator pedal can be typically used as the acceleration operator, a brake pedal can be typically used as the braking operator, and a steering wheel can be typically used as the steering operator. The operation type of these operators is not limited to this example, and, for example, another arrangement such as a lever type or a switch type may be used for these operators.

The traveling environment detection unit 13 is a detection device (or a monitoring device configured to monitor the state outside the vehicle) configured to detect a traveling environment. As the traveling environment detection unit 13, a known in-vehicle sensor necessary for implementing driving support to be described later is used. Examples are a radar (millimeter wave radar), a LiDAR (Light Detection and Ranging), and an image capturing camera. The traveling environment detection unit 13 may simply be referred to as a detection unit, or may be referred to as a monitoring unit or the like. The traveling environment as the detection target of the traveling environment detection unit 13 will be described later in detail, but includes, for example, a physical boundary of a road, a division line (for example, a white line) provided on a road, and the like.

The storage unit 14 stores map data necessary for implementing driving support to be described later. In this embodiment, the map data is prepared in advance and stored in the storage unit 14. As another embodiment, the map data may be acquired by external communication and stored in the storage unit 14 or updated. In this embodiment, to facilitate understanding of a description to be made later, the map data represents the traveling environment of the vehicle 1, for example, a physical boundary of a road, a division line provided on a road, and the like. As another embodiment, the map data may be indirect information that enables acquisition of these by predetermined arithmetic processing.

The control unit 15 is a system controller that controls the entire system of the vehicle 1, and can be typically formed by an ECU (Electronic Control Unit) including a CPU (Central Processing Unit) and a memory. That is, the functions of the control unit 15 can be implemented by executing a program on a computer. In many cases, the control unit 15 is formed by a plurality of ECUs capable of communicating with each other, but may be formed by a single ECU. In place of an ECU, a known semiconductor device such as an ASIC (Application Specific Integrated Circuit) may be used. That is, the functions of the control unit 15 can be implemented by either software or hardware.

As an example, the control unit 15 can execute driving support by performing drive control of the driving operation unit 12 based on the detection result of the traveling environment detection unit 13 and the map data in the storage unit 14. The driving support here means that the control unit 15 executes some or all of driving operations.

That is, the vehicle 1 has, as operation modes, a manual driving mode in which the subject of the driving operation is the user (driver) and a driving support mode (to be also referred to as an automated driving mode) in which the subject of the driving operation is the control unit 15. For example, in the manual driving mode, the user performs the driving operation using the driving operation unit 12.

On the other hand, in the driving support mode, the control unit 15 performs driving support based on the detection result of the traveling environment detection unit 13 and the map data in the storage unit 14, and causes the vehicle 1 to travel to a destination set by the user. More specifically, the control unit 15 sets the traveling route of the vehicle 1 so as to avoid obstacles (for example, objects such as an installed object, another vehicle, and a pedestrian whose contact with the vehicle 1 should be avoided) around the vehicle 1, and performs drive control of the traveling unit 11 such that the vehicle 1 travels along the traveling route. That is, the traveling route in this specification includes not only a route (a traveling route in a broad sense) to a destination but also a track (a traveling route in a narrow sense) that the vehicle 1 should draw on the road on which the vehicle 1 is actually traveling.

Note that a GPS (Global Positioning System) sensor or the like can be provided in the vehicle 1 such that the control unit 15 can appropriately refer to corresponding map data in the storage unit 14.

From the above-described viewpoints, it can be said that the control unit 15 functions as a driving support device, and its concept includes a traveling route setting device, a traveling control device, and the like. Here, to facilitate the description, these functions are assumed to be implemented by the control unit 15. These functions are implemented by the control unit 15, and some or all of the units that implement the functions may individually be provided.

### Detailed Examples of Traveling Route

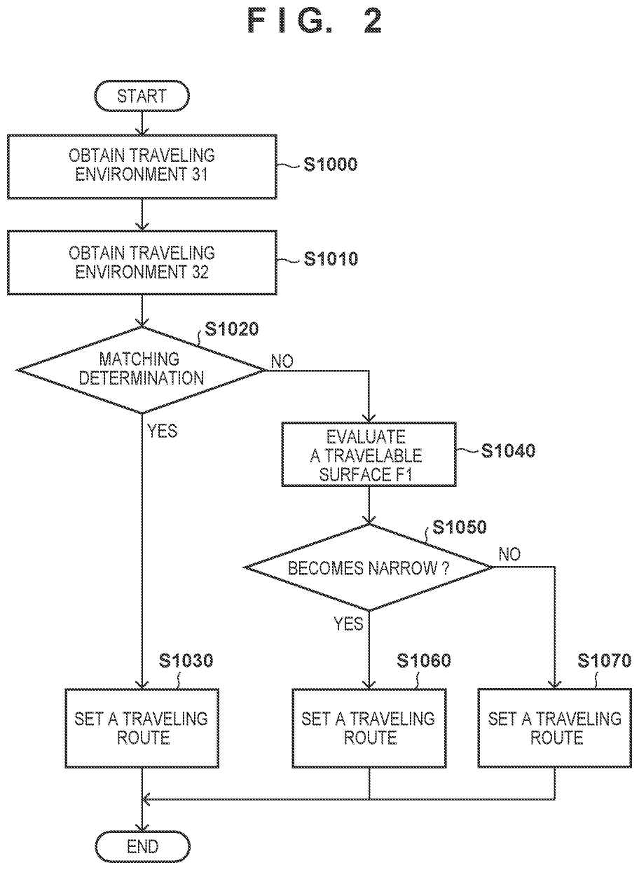

FIG. 2 is a flowchart showing an example of a method of setting the traveling route of the vehicle 1. This flowchart is mainly executed by the control unit 15 in accordance with the start of the driving support mode. As its outline, the traveling route of the vehicle 1 is set based on a traveling environment represented by map data in the storage unit 14 and a traveling environment represented by the detection result of the traveling environment detection unit 13.

In step S1000 (to be simply referred to as “S1000” hereinafter, and this also applies to other steps to be described later), map data in the storage unit 14 is referred to, and a traveling environment (traveling environment 31) represented by the map data is acquired.

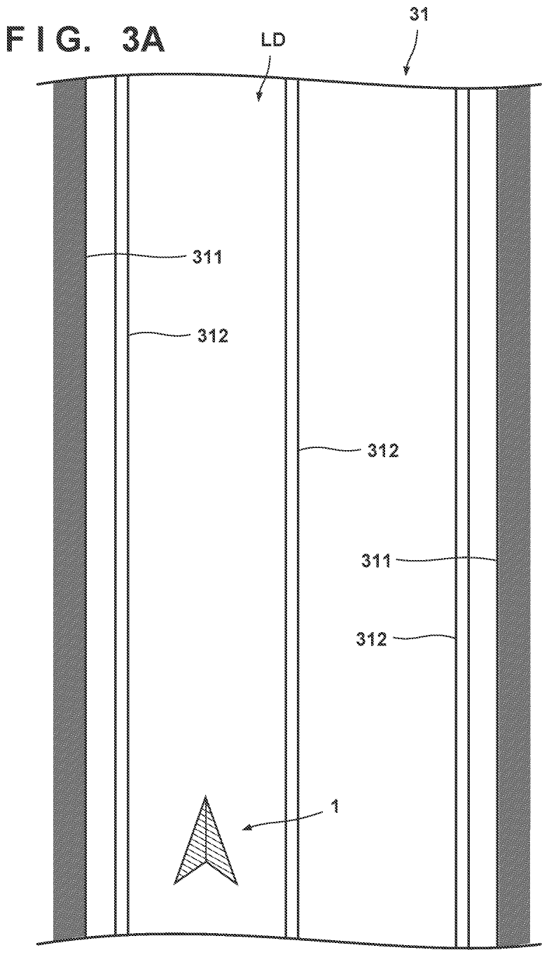

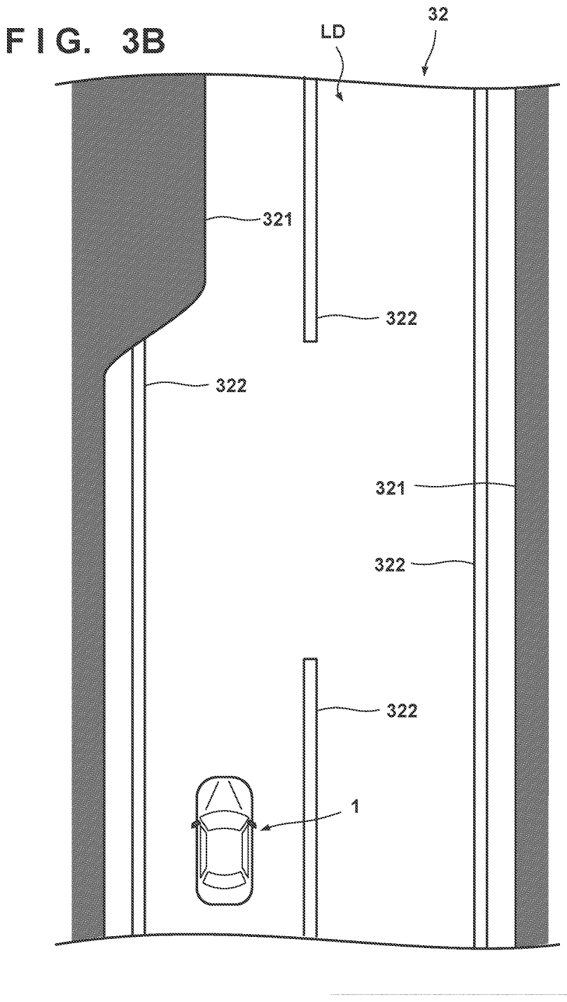

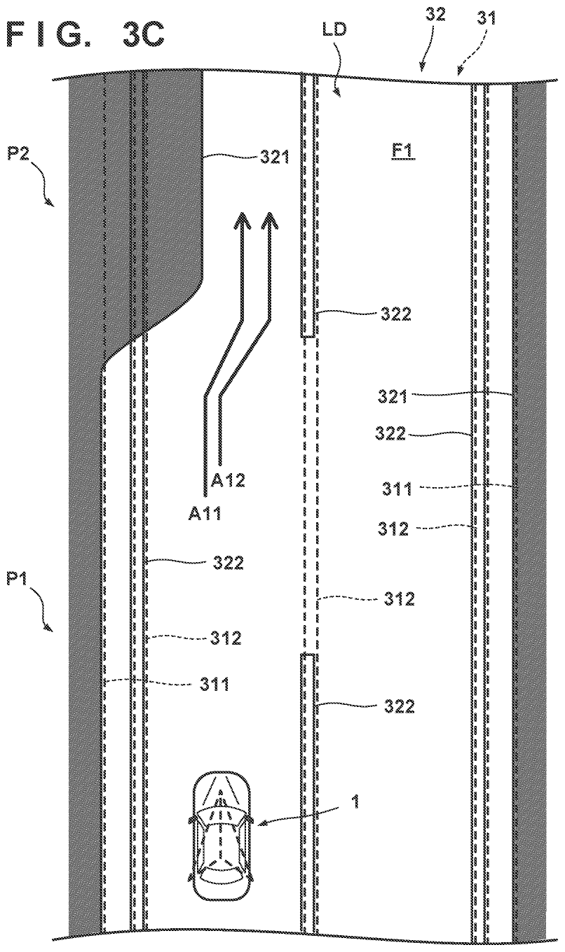

FIG. 3A shows the contents of the traveling environment 31 represented by the map data (a schematic plan view is shown to facilitate understanding). That is, the traveling environment 31 includes, for a road LD on which the vehicle 1 is actually traveling, physical boundaries 311 of the road LD on the front side of the vehicle 1 in the advancing direction, and division lines 312 provided on the road LD. Note that, in fact, a case in which the physical boundaries 311 or the division lines 312 are not registered as map data, a case in which these are missing from the map data, and the like can also be considered. Here, to facilitate understanding, these cases are not taken into consideration.

In S1010, a traveling environment (traveling environment 32) detected by the traveling environment detection unit 13 is acquired. As described above, examples of the traveling environment detection unit 13 are known in-vehicle sensors such as a radar, a LiDAR, and a camera, and the traveling environment 32 can be acquired by any of these.

FIG. 3B shows the contents of the traveling environment 32 detected by the traveling environment detection unit 13 (like FIG. 3A, a schematic plan view is shown to facilitate understanding). That is, the traveling environment 32 includes physical boundaries 321 of the road LD, and division lines 322 provided on the road LD. FIG. 3B shows a state in which on the road LD, accumulated snow exists inside the road LD in the width direction so as to cover the division line 322. Note that, in fact, a case in which the division lines 322 are not provided on the road LD, a case in which these have disappeared from the road LD, and the like can also be considered. Here, to facilitate understanding, these cases are not taken into consideration.

In S1020, it is determined whether the degree of matching between the traveling environments 31 and 32 satisfies a reference. More specifically, the determination can be done based on the degree of matching between the physical boundaries 311 and 321 and the degree of matching between the division lines 312 and 322. The reference may be set to, for example, 90%. The reference can arbitrarily be adjusted, and may be set to another value such as 85% or 95%. In this embodiment, the reference of the degree of matching for the physical boundaries 311 and 321 and the reference of the degree of matching for the division lines 312 and 322 are set to the same value. As another embodiment, the references may be set to values different from each other.

FIG. 3C shows a view in which the traveling environment 31 shown in FIG. 3A and the traveling environment 32 shown in FIG. 3B are superimposed (for the sake of discrimination, the traveling environment 31 is indicated by a broken line, and the traveling environment 32 is indicated by a solid line). In this example, of portions P1 and P2 of the road LD, accumulated snow exists in the portion P2. Hence, the degree of matching between the traveling environments 31 and 32 satisfies the reference in the portion P1 and does not satisfy the reference in the portion P2.

If the degree of matching between the traveling environments 31 and 32 satisfies the reference as the result of determination of S1020, the process advances to S1030. Otherwise (in a case of mismatching), the process advances to S1040.

In S1030, the traveling route is set. Here, the traveling route is set based on the traveling environment 31. When the traveling environment 31 (that is, map data) of the traveling environments 31 and 32 is used, the calculation time needed to set the traveling route can be made relatively short, and the setting can be implemented relatively easily. Note that since it is determined in S1020 that the degree of matching between the traveling environments 31 and 32 satisfies the reference, the traveling route may be set based on the traveling environment 32.

In S1040, based on the traveling environment 32 detected by the traveling environment detection unit 13, for the road LD, a traveling surface (to be referred to as a travelable surface hereinafter) F1 on which the vehicle 1 can actually travel is evaluated. This evaluation is performed based on the projecting form of the boundary lines of the travelable surface F1 to the inner side of the road LD in the width direction. Here, since the travelable surface F1 is substantially defined based on the physical boundaries 321, the boundary lines of the travelable surface F1 correspond to the physical boundaries 321. That is, the boundary lines of the travelable surface F1 are specified based on the physical boundaries 321 regardless of the division lines 322.

In S1050, it is determined, based on the evaluation result in S1040, whether the travelable surface F1 becomes narrow. For example, if the projecting form (the projecting form to the inner side of the road LD in the width direction) of the boundary line of the travelable surface F1 satisfies a reference, that is, if the size of the projection to the inner side in the width direction exceeds a predetermined amount, it can be determined that the travelable surface F1 becomes narrow. As an example, if the boundary line of the travelable surface F1 projects to overlap the vehicle 1 at the viewpoint in the advancing direction of the vehicle 1 (when viewed in the advancing direction of the vehicle 1), it can be determined that the travelable surface F1 becomes narrow. In other words, if the tip of the projection of the boundary line is located on the inner side of the vehicle 1 with respect to one side end of the vehicle 1 (the end on the side of the physical boundary 321), or overlaps the end, it can be determined that the travelable surface F1 becomes narrow.

Upon determining in S1050 that the travelable surface F1 becomes narrow, the process advances to S1060. Otherwise, the process advances to S1070.

In S1060, the traveling route is set based on the boundary lines of the travelable surface F1 determined to become narrow in S1050.

In S1070, the traveling route is set based on the traveling environment 31, as in S1030.

According to this flowchart, the traveling route of the vehicle 1 is set based on the traveling environment 31 represented by the map data and the traveling environment 32 detected by the traveling environment detection unit 13. If the degree of matching between the traveling environments 31 and 32 satisfies the reference, the traveling route is set based on the traveling environment 31 (that is, map data), and the setting can be implemented relatively easily. On the other hand, if the degree of matching between the traveling environments 31 and 32 does not satisfy the reference (in a case of mismatching), and the travelable surface F1 detected by the traveling environment detection unit 13 becomes narrow, the setting of the traveling route is done based on the boundary lines of the travelable surface F1 (substantially the physical boundaries 321). This allows the vehicle 1 to travel along an appropriate traveling route (see an arrow A11 in FIG. 3C). That is, the control unit 15 can provide appropriate driving support.

In addition, according to the example shown in FIG. 3C (additionally FIGS. 3A and 3B), the division line 322 is specified for one side of the road LD in the width direction, and the physical boundary 321 is specified for the other side. As another mode in this example, the traveling route may be set closer to the side of the specified division line 322 regardless of the traveling environment 31 (see an arrow A12 in FIG. 3C). This allows the vehicle 1 to travel in a state in which it is apart from the physical boundary 321.

### Other Examples of Traveling Route Setting Method

If the traveling environment 31 represented by the map data in the storage unit 14 and the traveling environment 32 represented by the detection result of the traveling environment detection unit 13 do not match (if the degree of matching does not satisfy the reference), various cases can be considered. That is, the above-described flowchart (see FIG. 2) assumes that both the physical boundaries 311 and the division lines 312 are registered as map data in advance, and the division lines 322 are provided on the road LD. In fact, cases in which the assumption does not hold can be considered.

For example, a case in which the physical boundaries 311 or the division lines 312 are not registered as map data, a case in which these are missing from the map data, and the like can be considered. Alternatively, a case in which the division lines 322 are not provided on the road LD at all, a case in which these have disappeared from the road LD, and the like can also be considered.

For this reason, in place of S1070 (if the traveling environments 31 and 32 do not match, and it is determined that the travelable surface F1 does not become narrow), setting of the traveling route can be performed based on several arithmetic processes.

### First Example

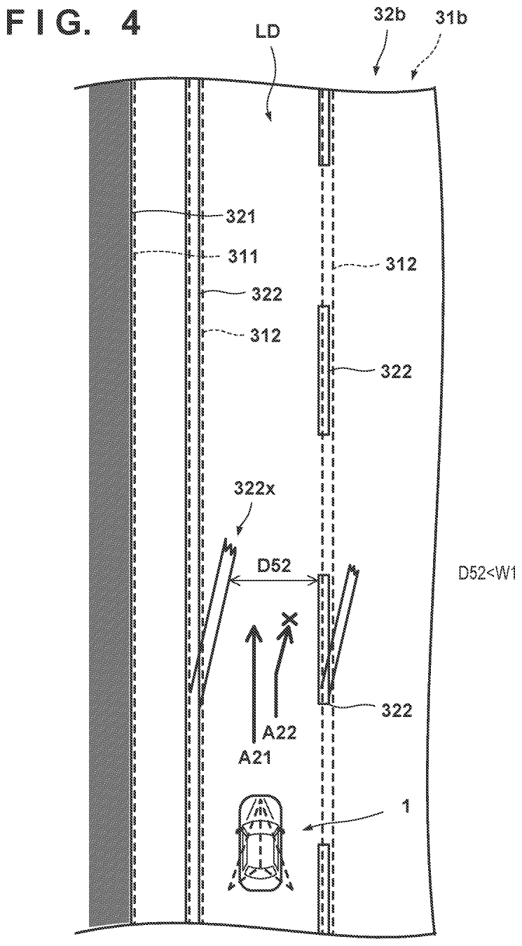

FIG. 4 shows a traveling environment 32b as another example of the traveling environment 32 together with a corresponding traveling environment (a traveling environment represented by map data) 31b. According to the traveling environment 32b, the division lines 322 are specified for both sides of the road LD in the width direction, and a distance D52 between the specified division lines 322 is smaller than a reference value W1. As this example, a case in which the division line 322 is newly provided by a road work or the like, and the old division line 322 (shown as a division line 322x for the sake of discrimination) remains can be considered. The reference value W1 can be set to, for example, 2.0 [m (meter)], 2.5 [m], or the like.

In this case, the traveling route is preferably set based on the traveling environment 31b (see an arrow A21 in FIG. 4). This can prevent a situation in which driving support is performed according to the inappropriate traveling environment 32b (see an arrow A22 in FIG. 4).

### Second Example

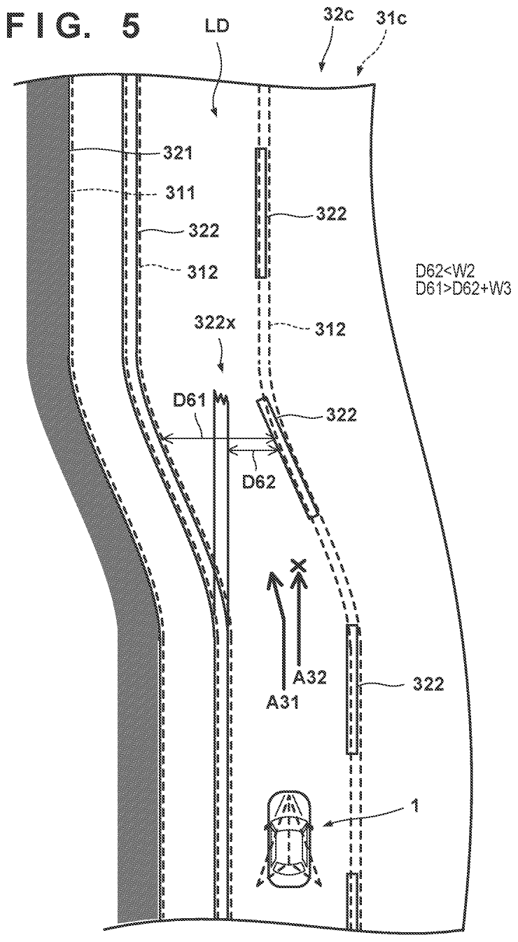

FIG. 5 shows a traveling environment 32c as still another example of the traveling environment 32 together with a corresponding traveling environment (a traveling environment represented by map data) 31c. According to the traveling environment 32c, the division lines 322 are specified for both sides of the road LD in the width direction, and a distance D62 between the specified division lines 322 is smaller than a reference value W2. Also, according to the traveling environment 31c, a distance D61 between the division lines 312 is larger than the distance D62 between the division lines 322 by a reference value W3 or more. As this example, like the above-described first example, a case in which the division line 322 is newly provided by a road work or the like, and the old division line 322 (shown as a division line 322x for the sake of discrimination) remains can be considered. The reference value W2 can be set to a value equal to or large than the reference value W1, and can be set to, for example, 2.5 [m], or the like. The reference value W3 can be set to, for example, 0.4 [m] or the like.

In this case, the traveling route is preferably set based on the traveling environment 31c (see an arrow A31 in FIG. 5). This can prevent a situation in which driving support is performed according to the inappropriate traveling environment 32c (see an arrow A32 in FIG. 5).

### Third Example

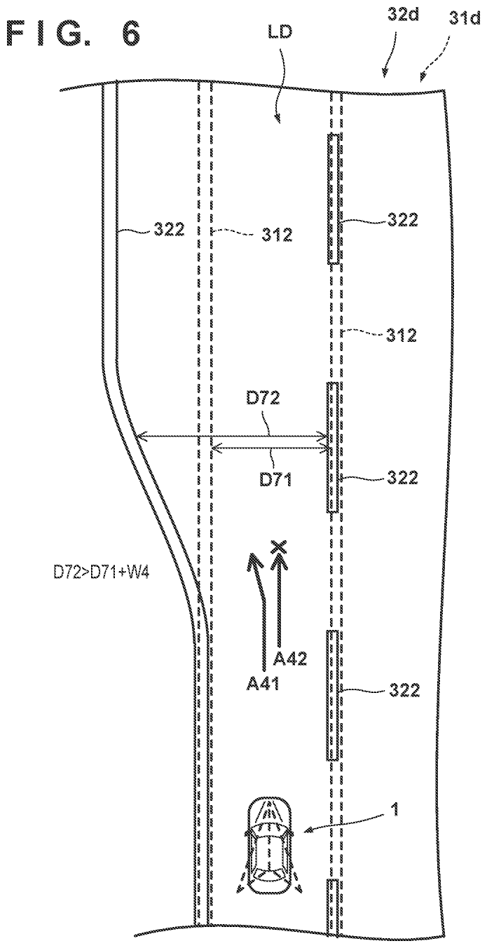

FIG. 6 shows a traveling environment 32d as still another example of the traveling environment 32 together with a corresponding traveling environment (a traveling environment represented by map data) 31d. According to the traveling environment 32d, the division lines 322 are specified for both sides of the road LD in the width direction, and a distance D72 between the specified division lines 322 is larger than a distance D71 between the division lines 312 represented by the traveling environment 31d by a reference value W4 or more. As this example, a case in which the division line 322 is newly provided by a road work or the like, but the map data (that is, the division lines 312) is not updated can be considered. The reference value W4 can be set to, for example, 0.5 [m], or the like.

In this case, the traveling route is preferably set based on the specified division lines 322 regardless of the traveling environment 31d represented by the map data (see an arrow A41 in FIG. 6). This can prevent a situation in which driving support is performed according to the inappropriate traveling environment 31d (see an arrow A42 in FIG. 6).

That is, if the traveling environments 31 and 32 do not match, the contents of S1070 can be changed by individually specifically examining each case such that the traveling route is set based on one of the traveling environments, which should actually be given priority. The reference values W1 to W4 exemplified here need to be appropriately set by individually specifically examining each case. Hence, the reference value W1 and the like exemplified here are not limited to the numerical values of the examples.

In the above description, to facilitate understanding, each element is denoted by a name associated with its function. However, each element need not always have the contents described in the embodiment as the main function, and may have those as an auxiliary function. For example, in this specification, the embodiment has been described by using the vehicle 1 as a typical example. However, the traveling unit 11 may be formed by a continuous track. That is, the contents of the embodiment can be applied to various kinds of moving bodies.

### Summary of Embodiment

The first aspect is related to a traveling route setting device (for example, 15), and the traveling route setting device is a traveling route setting device for setting a traveling route of a moving body (for example, 1), comprising an acquisition unit (for example, S1000-S1010) for acquiring a traveling environment represented by map data as a first traveling environment (for example, 31), and acquiring a traveling environment detected by a sensor (for example, 13) mounted in the moving body as a second traveling environment (for example, 32), and a setting unit (for example, S1030, S1060-S1070) for setting the traveling route of the moving body based on the first traveling environment and the second traveling environment, wherein in a case in which a degree of matching between the first traveling environment and the second traveling environment does not satisfy a reference, if a travelable surface (for example, F1) that is a traveling surface on which the moving body can actually travel and is detected by the sensor becomes narrow, the setting unit sets the traveling route based on a boundary line of the travelable surface (for example, S1030). This can provide appropriate driving support, and the moving body can travel along an appropriate traveling route.

In the second aspect, if the degree of matching satisfies the reference, the setting unit sets the traveling route based on the first traveling environment (for example, S1030). This makes it possible to implement the setting of the traveling route relatively easily.

Additionally, the traveling route setting device can further comprise a specifying unit (for example, S1040) for specifying the boundary line based on a physical boundary (for example, 321) of a road (for example, LD) regardless of a division line (for example, 322) provided on the road. This can appropriately implement the first aspect and the like.

In the third aspect, the device is further comprising an evaluation unit (for example, S1040) for evaluating a projecting form of the boundary line to an inner side of a road in a width direction on a front side of the moving body in an advancing direction and determination unit (for example, S1050) for determining, based on a result of the evaluation, that the travelable surface becomes narrow. This can appropriately implement the first aspect and the like.

In the fourth aspect, if the boundary line projects to overlap the moving body at a viewpoint in the advancing direction, the determination unit determines that the travelable surface becomes narrow. This makes it possible to execute the determination relatively easily.

In the fifth aspect, the acquisition unit acquires the second traveling environment by specifying, by the sensor, a division line (for example, 322) provided on a road (for example, LD) on a front side of the moving body in an advancing direction and/or a physical boundary (for example, 321) of the road, and if the division line is specified for one side of the road in the width direction, and the physical boundary is specified for the other side, the setting unit sets the traveling route closer to a side of the specified division line. Hence, the setting of the traveling route in the above case is appropriately performed.

In the sixth aspect, if division lines (for example, 322) are specified for both sides of the road (for example, LD) in the width direction, and a distance (for example, D52) between the specified division lines is smaller than a first reference value (for example, W1), the setting unit sets the traveling route based on the first traveling environment. Hence, the setting of the traveling route in the above case is appropriately performed.

In the seventh aspect, if division lines (for example, 322) are specified for both sides of the road (for example, LD) in the width direction, a distance (for example, D62) between the specified division lines is smaller than a second reference value (for example, W2), and a distance (for example, D61) between division lines represented by the first traveling environment is larger than the distance between the specified division lines by not less than a third reference value (for example, W3), the setting unit sets the traveling route based on the first traveling environment. Hence, the setting of the traveling route in the above case is appropriately performed.

In the eighth aspect, if division lines (for example, 322) are specified for both sides of the road (for example, LD) in the width direction, and a distance (for example, D72) between the specified division lines is larger than a distance (for example, D71) between division lines represented by the first traveling environment by not less than a fourth reference value (for example, W4), the setting unit sets the traveling route based on the specified division lines. Hence, the setting of the traveling route in the above case is appropriately performed.

In the ninth aspect, the traveling route setting device is a traveling control device (for example, 15), and further comprises a traveling control unit (for example, 11) for causing the moving body to travel along the traveling route. Hence, driving support is appropriately implemented along the set traveling route.

The 10th aspect is related to a method of setting a traveling route of a moving body, and the method is comprising acquiring a traveling environment represented by map data as a first traveling environment (for example, 31), and acquiring a traveling environment detected by a sensor (for example, 13) mounted in the moving body as a second traveling environment (for example, 32) (for example, S1000-S1010), and setting the traveling route of the moving body based on the first traveling environment and the second traveling environment (for example, S1030, S1060-S1070), wherein in the setting the traveling route, in a case in which a degree of matching between the first traveling environment and the second traveling environment does not satisfy a reference, if a travelable surface (for example, F1) that is a traveling surface on which the moving body can actually travel and is detected by the sensor becomes narrow, the traveling route is set based on a boundary line (for example, S1030) of the travelable surface. This can implement the same as in the first aspect.

The 11th aspect is related to a program, and the program causes a computer to execute each step of the above-described method. This can implement the same as in the first aspect.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A traveling route setting device for setting a traveling route of a moving body, comprising:
an acquisition unit for acquiring a traveling environment represented by map data as a first traveling environment, and acquiring a traveling environment detected by a sensor mounted in the moving body as a second traveling environment; and
a setting unit for setting the traveling route of the moving body based on the first traveling environment and the second traveling environment,
wherein in a case in which a degree of matching between the first traveling environment and the second traveling environment does not satisfy a reference, if a travelable surface that is a traveling surface on which the moving body can actually travel and is detected by the sensor becomes narrow, the setting unit sets the traveling route based on a boundary line of the travelable surface.

2. The device according to claim 1, wherein if the degree of matching satisfies the reference, the setting unit sets the traveling route based on the first traveling environment.

3. The device according to claim 1, further comprising:
an evaluation unit for evaluating a projecting form of the boundary line to an inner side of a road in a width direction on a front side of the moving body in an advancing direction; and
a determination unit for determining, based on a result of the evaluation, that the travelable surface becomes narrow.

4. The device according to claim 3, wherein if the boundary line projects to overlap the moving body at a viewpoint in the advancing direction, the determination unit determines that the travelable surface becomes narrow.

5. The device according to claim 1, wherein
the acquisition unit acquires the second traveling environment by specifying, by the sensor, a division line provided on a road on a front side of the moving body in an advancing direction and/or a physical boundary of the road, and
if the division line is specified for one side of the road in the width direction, and the physical boundary is specified for the other side, the setting unit sets the traveling route closer to a side of the specified division line.

6. The device according to claim 1, wherein if division lines are specified for both sides of the road in the width direction, and a distance between the specified division lines is smaller than a first reference value, the setting unit sets the traveling route based on the first traveling environment.

7. The device according to claim 1, wherein if division lines are specified for both sides of the road in the width direction, a distance between the specified division lines is smaller than a second reference value, and a distance between division lines represented by the first traveling environment is larger than the distance between the specified division lines by not less than a third reference value, the setting unit sets the traveling route based on the first traveling environment.

8. The device according to claim 1, wherein if division lines are specified for both sides of the road in the width direction, and a distance between the specified division lines is larger than a distance between division lines represented by the first traveling environment by not less than a fourth reference value, the setting unit sets the traveling route based on the specified division lines.

9. The device according to claim 1, wherein the traveling route setting device is a traveling control device, and further comprises a traveling control unit for causing the moving body to travel along the traveling route.

10. A method of setting a traveling route of a moving body, comprising:
acquiring a traveling environment represented by map data as a first traveling environment, and acquiring a traveling environment detected by a sensor mounted in the moving body as a second traveling environment; and
setting the traveling route of the moving body based on the first traveling environment and the second traveling environment,
wherein in the setting the traveling route, in a case in which a degree of matching between the first traveling environment and the second traveling environment does not satisfy a reference, if a travelable surface that is a traveling surface on which the moving body can actually travel and is detected by the sensor becomes narrow, the traveling route is set based on a boundary line of the travelable surface.

11. A non-transitory computer-readable storage medium storing a program configured to cause a computer to execute:
acquiring a traveling environment represented by map data as a first traveling environment, and acquiring a traveling environment detected by a sensor mounted in the moving body as a second traveling environment; and
setting a traveling route of the moving body based on the first traveling environment and the second traveling environment,
wherein in the setting the traveling route, in a case in which a degree of matching between the first traveling environment and the second traveling environment does not satisfy a reference, if a travelable surface that is a traveling surface on which the moving body can actually travel and is detected by the sensor becomes narrow, the traveling route is set based on a boundary line of the travelable surface.
